(19) United States
(12) Patent Application Publication
(10) Pub. No.: US 2024/0235929 A9
(43) Pub. Date: Jul. 11, 2024

(54) METHOD FOR INSTANTIATING EDGE APPLICATION SERVER AND APPARATUS

(71) Applicant: HUAWEI TECHNOLOGIES CO., LTD., Shenzhen (CN)

(72) Inventors: Qi YAO, Beijing (CN); Shitao LI, Nanjing (CN); Zaifeng ZONG, Nanjing (CN)

(21) Appl. No.: 18/405,034

(22) Filed: Jan. 5, 2024

Related U.S. Application Data
(63) Continuation of application No. PCT/CN2022/103709, filed on Jul. 4, 2022.

(30) Foreign Application Priority Data
Jul. 7, 2021 (CN) 202110766584.3

(51) Int. Cl. H04L 41/0806; H04L 41/0681; H04W 4/60

(52) U.S. Cl. CPC H04L 41/0806; H04L 41/0681; H04W 4/60

(57) ABSTRACT

A method for instantiating an edge application server and an apparatus. A first network element receives first information from a second network element. The first information includes network information and application information. The network information indicates a first network, and the application information indicates a first application. The first information further includes information about a first event that is related to the first application and that is in the first network. The first event is that an edge application server corresponding to the first application is not found in the first network. The first network element determines, in response to the first event meeting a first condition, to instantiate a first edge application server corresponding to the first application in the first network.

### CROSS-REFERENCE TO RELATED APPLICATIONS

This application is a continuation of International Application No. PCT/CN2022/103709, filed on Jul. 4, 2022, which claims priority to Chinese Patent Application No. 202110766584.3, filed on Jul. 7, 2021. The disclosures of the aforementioned applications are hereby incorporated by reference in their entireties.

### BACKGROUND

An edge data network (edge data network, EDN) is a local data center. The EDN includes an edge enabler server (edge enabler server, EES) and a plurality of edge application servers (edge application server, EAS). Each EDN has a specific service scope. The EES is a control network element or a management network element in a mobile edge computing (mobile edge computing, MEC) node, and is responsible for managing each EAS deployed in the EDN, for example, registration and domain name server (domain name server, DNS) parsing. In addition, the EES invokes a capability exposure function of a network.

User equipment (user equipment, UE) includes an edge enabler client (edge enabler client, EEC) and an application client (application client, AC). The EEC provides support for the application client on the UE, and the UE registers with the EES through an EDGE-1 interface.

In a conventional technology, in response to the UE registering with the EES, the EES detects whether the deployed EAS meets application information to be accessed by the UE. In response to the EES detecting that the deployed EAS does not meet the application information to be accessed by the UE or the EES finds that there is no instantiated EAS in the current EDN, how to meet an access request of the UE is not defined.

### SUMMARY

Embodiments described herein provide a method for instantiating an edge application server and an apparatus, to dynamically instantiate the edge application server.

According to a first aspect, a method for instantiating an edge application server is provided. The method is performed by a first network element, or is performed by a chip similar to a first network element. The first network element is an application service provider or a management system. In the method, the first network element receives first information from a second network element. The first information includes network information and application information. The network information indicates a first network, and the application information indicates a first application. The first information further includes information about a first event that is related to the first application and that is in the first network. The first event includes at least one of the following: an edge application server corresponding to the first application is not found in the first network, the edge enabler server corresponding to the first application is not found in the first network, and performance information of the edge application server corresponding to the first application in the first network. The first network element determines, in response to the first event meeting a first condition, to instantiate a first edge application server corresponding to the first application in the first network.

Based on the foregoing solution, the first network element determines, based on a first event reported by the second network element, to dynamically instantiate the edge application server of the first application in response to the first event meeting the first condition. This improves efficiency of operation and maintenance management.

In at least one embodiment, that the edge application server corresponding to the first application is not found in the first network includes: The edge application server corresponding to the first application is not deployed or instantiated in the first network.

In at least one embodiment, that the edge application server corresponding to the first application is not found in the first network includes: The edge application server corresponding to the first application that meets a terminal usage (UE used) is not found in the first network. In other words, although the edge application server corresponding to the first application is deployed or instantiated in the first network, performance of the edge application server of the first application cannot meet the terminal usage.

In at least one embodiment, in response to the first event includes that the edge application server corresponding to the first application not being found in the first network, the first condition includes that a quantity of times that the edge application server corresponding to the first application is not found in the first network in first duration is greater than or equal to a first threshold. In response to the first event includes that the edge enabler server corresponding to the first application not being found in the first network, the first condition includes that a quantity of times that the edge enabler server corresponding to the first application is not found in the first network in second duration is greater than or equal to a second threshold. In response to the first event including the performance information of the edge application server corresponding to the first application in the first network, the first condition includes at least one of the following: load of the edge application server is greater than or equal to a third threshold and the edge application server breaks down.

Based on the foregoing solution, in response to a plurality of terminals wanting to access the first application or one terminal wanting to access the first application for a plurality of times, the edge application server of the first application is instantiated. This improves user experience.

In at least one embodiment, the first network element sends an edge application server instantiation request to the management system, where the edge application server instantiation request is used to instantiate the edge application server, and the edge application server instantiation request includes the network information and the application information.

In at least one embodiment, the first information further includes a quantity of times that the first event occurs.

Based on the foregoing solution, the second network element reports the first event to the first network element in response to detecting the first event for a plurality of times. This improves utilization of transmission resources.

In at least one embodiment, a quantity of times that the edge enabler server corresponding to the first application is not found in the first network is a quantity of times that the first network element receives the first event. Alternatively, a quantity of times that the edge enabler server corresponding to the first application is not found in the first network is a quantity of times that the first network element receives the first event.

Based on the foregoing solution, the second network element reports the first event to the first network element for a plurality of times, and reports a usage of the terminal to the first network element in time in response to the terminal wanting to access the first application but the edge application server of the first application not being deployed in the network. This improves user experience.

In at least one embodiment, in response to the first network element being a management system, before the first network element instantiates, in the first network, the first edge application server corresponding to the first application, the first network element obtains, from an application service provider, application installation information that is allowed to be instantiated.

Based on the foregoing solution, after obtaining the application installation information that is allowed to be instantiated, the management system directly communicates with the second network element. This reduces complexity.

In at least one embodiment, the first network element sends second information to the second network element, where the second information indicates that the first edge application server is successfully instantiated.

In at least one embodiment, the first network element subscribes to the first information.

Based on the foregoing solution, the first network element subscribes to the first information, to receive first information of the second network element. This improves a success rate of receiving the first information by the first network element.

According to a second aspect, a method for instantiating an edge application server is provided. The method is performed by a second network element, or is performed by a chip having a function similar to a function of a second network element. The second network element is an edge enabler server or an edge network configuration server. In the method, the second network element detects a first event. The first event includes at least one of the following: an edge application server corresponding to a first application is not found in a first network, an edge enabler server corresponding to the first application is not found in the first network, and performance information of the edge application server corresponding to the first application in the first network. The second network element sends first information to a first network element or sends indication information to one or more terminals based on the detected first event. The first information includes network information and application information, and the indication information indicates that the edge application server is to be instantiated. The network information indicates the first network, and the application information indicates the first application.

In at least one embodiment, that an edge enabler server corresponding to the first application is not found in the first network includes: The edge application server corresponding to the first application is not deployed or instantiated in the first network, or the edge application server corresponding to the first application that meets a terminal usage (UE used) is not found in the first network, and an edge configuration server determines that the edge enabler server corresponding to the first application is not found in the first network.

In at least one embodiment, the indication information indicates that the edge application server or the edge enabler server corresponding to the first application is not found in the first network, or indicates that registration fails. A name of the indication information is not limited.

Based on the foregoing solution, the second network element reports, to the first network element, a first event that is related to the first application and that is detected in the first network, so that the first network element determines whether to instantiate the edge application server in the first network.

In at least one embodiment, the second network element receives second information, where the second information indicates that a first edge application server is successfully instantiated, and the first information is used to determine whether to instantiate the first edge application server.

Based on the foregoing solution, the first network element determines, based on a first event reported by the second network element, to dynamically instantiate the edge application server of the first application in response to the first event meeting the first condition. This improves efficiency of operation and maintenance management.

In at least one embodiment, the first information further includes a quantity of times that the first event occurs.

In at least one embodiment, the indication information indicates that the edge application server fails to be found or the edge enabler client fails to be registered.

Based on the foregoing solution, the second network element indicates, to the one or more terminals through the indication information, whether the edge application server is to be dynamically instantiated.

According to a third aspect, a method for instantiating an edge application server is provided. The method is performed by a first network element, or is performed by a chip having a function similar to a function of a first network element. The first network element is an application service provider or a management system. In the method, the first network element receives first request information from one or more terminals, where the first request information is used to request to instantiate an edge application server. The first request information includes network information, application information, and a terminal identifier. The network information indicates a first network, the application information indicates a first application, and the terminal identifier identifies a terminal that sends the first request information. The first network element determines, based on the first request information, whether to instantiate the edge application server corresponding to the first application in the first network.

Based on the foregoing solution, the terminal sends the first request information to the first network element, to request to instantiate the edge application server of the first application in the first network, so that differentiated service experience is provided for the terminal. This improves efficiency of operation and maintenance management.

In at least one embodiment, in response to a quantity of one or more terminals reaching a first threshold, a determination is made to instantiate the edge application server corresponding to the first application in the first network; and/or in response to a subscription level of the terminal identified by the terminal identifier being higher than or equal to a specified level, a determination is made to instantiate the edge application server corresponding to the first application in the first network.

Based on the foregoing solution, in response to a plurality of terminals wanting to access the first application or wanting to access a high subscription level of the first application, the edge application server of the first application is instantiated, so that differentiated service experience is provided for the terminal. This improves efficiency of operation and maintenance management.

In at least one embodiment, the first network element sends second request information to a management system. The second request information is used to request to instantiate the edge application server, and the second request information includes the network information and the application information.

In at least one embodiment, the network information includes at least one of a network identifier and a location identifier. The network identifier and the location identifier identifies the first network, and the application information includes at least one of an application identifier and an application performance usage.

In at least one embodiment, in response to the first network element being a management system, before the first network element determines to instantiate the edge application server corresponding to the first application in the first network, the first network element obtains, from an application service provider, application installation information that is allowed to be instantiated.

Based on the foregoing solution, after obtaining the application installation information that is allowed to be instantiated, the management system directly communicates with the terminal. This reduces complexity.

In at least one embodiment, the first network element sends second information to a second network element or one or more terminals, and the second information indicates that the edge application server corresponding to the first application is successfully instantiated.

In at least one embodiment, in response to a quantity of one or more terminals not reaching a first threshold, third information is sent to the one or more terminals. The third information indicates that the edge application server of the first application is not found in the first network; and/or the third information is sent to the one or more terminals in response to the subscription level of the terminal identified by the terminal identifier is lower than the specified level. The third information indicates that the edge application server of the first application is not found in the first network.

Based on the foregoing solution, in response to the foregoing condition not being met, the first network element sends the third information to the terminal. In other words, the edge application server of the first application is not instantiated in the first network. This saves resources in an EDN network.

According to a fourth aspect, a method for instantiating an edge application server is provided. The method is performed by a terminal, or is performed by a chip with a function similar to a function of a terminal. In the method, an edge enabler client receives indication information from an edge enabler server or an edge network configuration server. The indication information indicates that an edge application server fails to be found, or the edge enabler client fails to be registered, or the edge application server is to be instantiated. The edge enabler client sends request information to a first network element based on the indication information, where the request information includes network information and application information. The network information indicates a first network, and the application information indicates a first application.

Based on the foregoing solution, the terminal sends the first request information to the first network element, to request to instantiate the edge application server of the first application in the first network, so that differentiated service experience is provided for the terminal. This improves efficiency of operation and maintenance management.

In at least one embodiment, the edge enabler client sends the indication information to an application client.

In at least one embodiment, the edge enabler client receives request information from the application client.

In at least one embodiment, the edge enabler client receives second information from the first network element, where the second information indicates that an edge application server corresponding to the first application is successfully instantiated.

According to a fifth aspect, a communication apparatus is provided. The apparatus includes modules/units configured to perform the first aspect, for example, a transceiver unit and a processing unit.

The transceiver unit is configured to receive first information from a second network element, where the first information includes network information and application information, the network information indicates a first network, the application information indicates a first application, and the first information further includes information about a first event that is related to the first application and that is in the first network; and the first event includes at least one of the following: an edge application server corresponding to the first application is not found in the first network, the edge enabler server corresponding to the first application is not found in the first network, and performance information of the edge application server corresponding to the first application in the first network. The processing unit is configured to determine, in response to the first event meeting a first condition, to instantiate a first edge application server corresponding to the first application in the first network.

In at least one embodiment, in response to the first event includes that the edge application server corresponding to the first application not being found in the first network, the first condition includes that a quantity of times that the edge application server corresponding to the first application is not found in the first network in first duration is greater than or equal to a first threshold; in response to the first event includes that the edge enabler server corresponding to the first application not being found in the first network, the first condition includes that a quantity of times that the edge enabler server corresponding to the first application is not found in the first network in second duration is greater than or equal to a second threshold; and in response to the first event including the performance information of the edge application server corresponding to the first application in the first network, the first condition includes at least one of the following: load of the edge application server is greater than or equal to a third threshold and the edge application server breaks down.

In at least one embodiment, the transceiver unit is further configured to send an edge application server instantiation request to the management system, where the edge application server instantiation request is used to instantiate the edge application server, and the edge application server instantiation request includes the network information and the application information.

In at least one embodiment, the first information further includes a quantity of times that the first event occurs.

In at least one embodiment, a quantity of times that the edge enabler server corresponding to the first application is not found in the first network is a quantity of times that the first network element receives the first event; or a quantity of times that the edge enabler server corresponding to the first application is not found in the first network is a quantity of times that the first network element receives the first event.

In at least one embodiment, the processing unit is further configured to obtain, from an application service provider, application installation information that is allowed to be instantiated.

In at least one embodiment, the transceiver unit is further configured to send second information to the second network element, where the second information indicates that the first edge application server is successfully instantiated.

In at least one embodiment, the transceiver unit is further configured to send a subscription request to the second network element, where the subscription request is used to subscribe to the first information.

According to a sixth aspect, a communication apparatus is provided. The apparatus includes modules/units configured to perform the second aspect, for example, a transceiver unit and a processing unit.

The processing unit is configured to detect a first event, where the first event includes at least one of the following: an edge application server corresponding to a first application is not found in a first network, an edge enabler server corresponding to the first application is not found in the first network, and performance information of the edge application server corresponding to the first application in the first network; the transceiver unit is configured to send first information to a first network element or send indication information to one or more terminals based on the detected first event; the first information includes network information and application information, and the indication information indicates that an edge application server is to be instantiated; and the network information indicates the first network, and the application information indicates the first application.

In at least one embodiment, the transceiver unit is further configured to receive second information, where the second information indicates that a first edge application server is successfully instantiated, and the first information is used to determine whether to instantiate the first edge application server.

In at least one embodiment, the first information further includes a quantity of times that the first event occurs.

In at least one embodiment, the indication information indicates that the edge application server fails to be found or the edge enabler client fails to be registered.

According to a seventh aspect, a communication apparatus is provided. The apparatus includes modules/units configured to perform a third aspect, for example, a transceiver unit and a processing unit.

The transceiver unit is configured to receive first request information from one or more terminals, where the first request information is used to request to instantiate an edge application server; the first request information includes network information, application information, and a terminal identifier; and the network information indicates a first network, the application information indicates a first application, and the terminal identifier identifies a terminal that sends the first request information; and the processing unit is configured to determine, based on the first request information, whether to instantiate the edge application server corresponding to the first application in the first network.

In at least one embodiment, in response to determining, based on the first request information, whether to instantiate the edge application server corresponding to the first application in the first network, the processing unit is specifically configured to: in response to a quantity of one or more terminals reaches a first threshold, determine to instantiate the edge application server corresponding to the first application in the first network; and/or in response to a subscription level of the terminal identified by the terminal identifier being higher than or equal to a specified level, determine to instantiate the edge application server corresponding to the first application in the first network.

In at least one embodiment, the transceiver unit is further configured to send second request information to a management system, where the second request information is used to request to instantiate the edge application server, and the second request information includes the network information and the application information.

In at least one embodiment, the network information includes at least one of a network identifier and a location identifier; and the network identifier and the location identifier identify the first network, and the application information includes at least one of an application identifier and an application performance usage.

In at least one embodiment, the processing unit is further configured to obtain, from an application service provider, application installation information that is allowed to be instantiated.

In at least one embodiment, the transceiver unit is further configured to send second information to the second network element or one or more terminals, where the second information indicates that the first application provides a corresponding edge application server that is successfully instantiated.

In at least one embodiment, the transceiver unit is further configured to: in response to a quantity of one or more terminals not reaching a first threshold, send third information to the one or more terminals, where the third information indicates that the edge application server of the first application is not found in the first network; and/or send the third information to the one or more terminals in response to the subscription level of the terminal identified by the terminal identifier being lower than the specified level, where the third information indicates that the edge application server of the first application is not found in the first network.

According to an eighth aspect, a communication apparatus is provided. The apparatus includes modules/units configured to perform the fourth aspect, for example, a transceiver unit and a processing unit.

The transceiver unit is configured to receive indication information from an edge enabler server or an edge network configuration server, where the indication information indicates that an edge application server fails to be found, or an edge enabler client fails to be registered, or an edge application server is to be instantiated. The processing unit is configured to generate request information based on the indication information. The request information includes network information, application information, and a terminal identifier; and the network information indicates a first network, the application information indicates a first application, and the terminal identifier identifies a terminal that sends the request information. The transceiver unit is further configured to send the request information to a first network element.

In at least one embodiment, the transceiver unit is further configured to: send the indication information to an application client; and receive request information from the application client.

In at least one embodiment, the transceiver unit is further configured to receive second information from the first network element, where the second information indicates that an edge application server corresponding to the first application is successfully instantiated.

According to a ninth aspect, a communication apparatus is provided, including a processor and a memory. The memory is configured to store a computer program or instructions. The processor executes the computer program or the instructions in the memory, to implement the first aspect, or the second aspect, or the third aspect, or the fourth aspect.

The memory is located inside the apparatus, or is located outside the apparatus, and is connected to the apparatus.

In at least one embodiment, the memory is integrated with the processor.

In at least one embodiment, the communication apparatus further includes a transceiver. The transceiver performs a receiving and sending operation of the method in the first aspect, or performs a receiving and sending operation of the method in the second aspect, or performs a receiving and sending operation of the method in the third aspect, or performs a receiving and sending operation of the method in the fourth aspect.

According to a tenth aspect, a chip is provided. The chip includes a logic circuit and a communication interface.

For example, the communication interface is configured to input first information, where the first information includes network information and application information, the network information indicates a first network, the application information indicates a first application, and the first information further includes information about a first event that is related to the first application and that is in the first network. The first event includes at least one of the following: an edge application server corresponding to the first application is not found in the first network, the edge enabler server corresponding to the first application is not found in the first network, and performance information of the edge application server corresponding to the first application in the first network. The logic circuit is configured to: in response to the first event meeting a first condition, instantiate a first edge application server corresponding to the first application in the first network.

For example, the logic circuit is configured to detect the first event. The first event includes at least one of the following: an edge application server corresponding to the first application is not found in the first network, the edge enabler server corresponding to the first application is not found in the first network, and performance information of the edge application server corresponding to the first application in the first network. The communication interface is configured to output the first information or indication information, where the first information includes network information and application information, and the indication information indicates that an edge application server is to be instantiated; and the network information indicates the first network, and the application information indicates the first application.

For example, a user of the communication interface enters first request information, where the first request information is used to request to instantiate the edge application server; the first request information includes network information, application information, and a terminal identifier; and the network information indicates a first network, the application information indicates a first application, and the terminal identifier identifies a terminal that sends the first request information. The logic circuit is configured to determine, based on the first request information, whether to instantiate the edge application server corresponding to the first application in the first network.

For example, the communication interface is configured to input the indication information, where the indication information indicates that the edge application server fails to be found, or the edge enabler client fails to be registered, or the edge application server is to be instantiated. The logic circuit is configured to generate request information based on the indication information. The request information includes network information, application information, and a terminal identifier; and the network information indicates a first network, the application information indicates a first application, and the terminal identifier identifies a terminal that sends the request information. The communication interface is further configured to output the request information.

According to an eleventh aspect, this application provides a computer-readable storage medium. The computer-readable storage medium stores instructions. In response to the instructions being run on a computer, the computer is enabled to perform the method in the foregoing aspects.

According to a twelfth aspect, at least one embodiment provides a computer program product for storing instructions. In response to the computer program product being run on a computer, the computer is enabled to perform the method in the foregoing aspects.

According to a thirteenth aspect, at least one embodiment provides a communication system, including at least one first network element and at least one second network element, or including at least one first network element and at least one terminal.

In addition, for beneficial effects of the fifth aspect to the thirteenth aspect, refer to the beneficial effects shown in the first aspect to the fourth aspect.

### BRIEF DESCRIPTION OF DRAWINGS

FIG. 1 is an example flowchart of EEC registration;

FIG. 2 shows a network architecture according to at least one embodiment;

FIG. 3 is an example flowchart of a method for instantiating an EAS according to at least one embodiment;

FIG. 4 is an example flowchart of a method for instantiating an EAS according to at least one embodiment;

FIG. 5 is an example flowchart of a method for instantiating an EAS according to at least one embodiment;

FIG. 6A and FIG. 6B are an example flowchart of a method for instantiating an EAS according to at least one embodiment;

FIG. 7 is a structural diagram of a communication apparatus according to at least one embodiment; and

FIG. 8 is a block diagram of a communication apparatus according to at least one embodiment.

### DESCRIPTION OF EMBODIMENTS

For ease of understanding, terms in at least one embodiment are first explained and described.

(1) An EAS of a first application is an EAS that provides a service for the first application, or is referred to as an EAS corresponding to the first application, an EAS that corresponds to the first application, an EAS that provides a service for the first application, an EAS that provides a service for the first application, or the like.

An EDN includes an EES and a plurality of EASs. Each EDN has a specific service range. The EES is a control network element or a management network element in an MEC node. In an MEC architecture of the European telecommunication standard institute (European telecommunication standard institute, ETSI), one EDN is also referred to as the MEC node, an MEC site, or the like. The MEC node includes an MEC platform (MEC platform, MEP) and an MEC application (application). The EES and the MEC have similar functions, and the EAS and the MEC application have similar functions.

An edge configuration server (edge configuration server, ECS) is a global management network element, and maintains information of each EDN, including a service range, an EES address, and the like. In some standard protocols, such as technical specification (technical specification, TS) 23.501, TS23.502, and the like, the foregoing EES, EAS, ECS, MEP, and the like is referred to as application function (application function, AF) network elements.

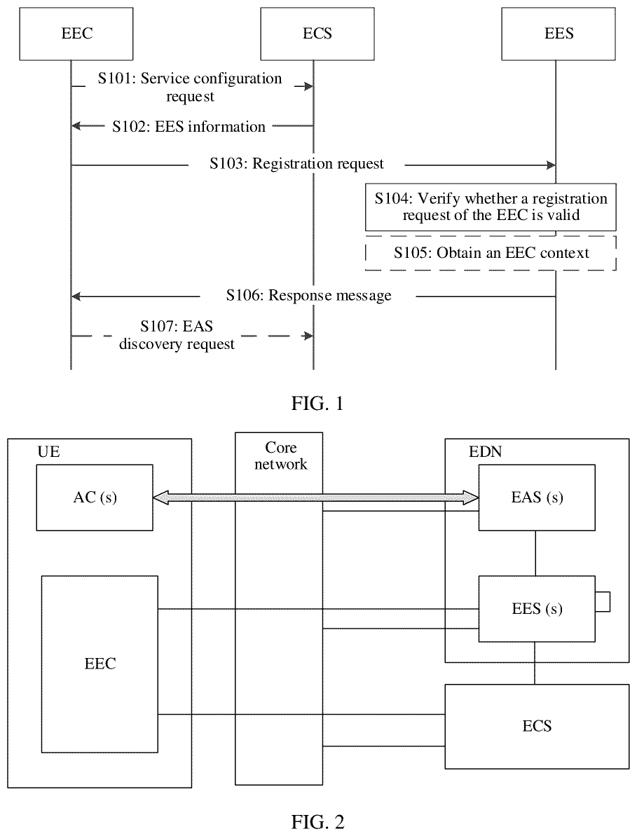

FIG. 1 is a flowchart of registering an EEC with an EES, and the following operations are included.

S101: An EEC sends a service configuration request (service provisioning request) to an ECS.

The service configuration request includes application information that UE wants to access, for example, an application identifier, an application performance usage, and/or the like.

S102: The ECS sends information about an EES to the EEC.

The ECS searches for an EES that meets an application that the UE wants to access. For example, the ECS searches for, based on the application identifier, an EDN in which a corresponding EAS is deployed. In response to the ECS finding the EDN, the ECS sends the information about the EES in the found EDN to the EEC.

S103: The EEC sends a registration request to the EES.

The registration request carries an EEC identifier, a security certificate, the application information that the UE wants to access, such as the application identifier, the application performance, and the like, and an EEC context identifier.

S104: The EES verifies whether the registration request of the EEC is valid.

The EES verifies whether the EEC identifier is consistent with the security certificate. In response to the EEC identifier being consistent with the security certificate, the registration request is valid; or in response to the EEC identifier being inconsistent with the security certificate, the registration request is considered invalid.

In addition, the EES further determines whether the deployed EAS meets an access usage of the UE. For example, the EES determines whether an EAS of an application requested by the UE is deployed. Alternatively, the EES determines whether the deployed EAS meets the usage of the UE, for example, determines whether a bandwidth, a delay, and the like of the deployed EAS meet the usage of the UE.

Optionally, the following operation S105 is further performed.

S105: The EES obtains an EEC context based on an EEC context identifier.

The EES determines, based on the EEC context identifier, the EES with which the UE has registered, and obtain the EEC context from the EES with which the UE has registered.

S106: The EES sends a response message to the EEC, to notify the EEC of whether registration succeeds.

After the EEC registration succeeds, the following operation S107 is further performed.

S107: The EEC sends an EAS discovery request to the EES.

The EAS discovery request includes application information. The EES searches for, based on the application information, the EAS that meets the application that the UE wants to access. In response to the EES being found, the EES sends information about the found EAS to the EEC.

In S104, in response to the EES detecting that the deployed EAS does not meet the application information that the UE wants to access, or after the EEC sends the registration request to the EES in S103, the EES finds that the EAS is not instantiated in the current EDN, or after the EEC sends the EAS discovery request to the EES in S107, the EES does not find the EAS that meets the application information that the UE wants to access, and the EES dynamically triggers one EAS to meet the request of the EEC. However, how to dynamically instantiate the EAS is not defined.

Embodiments described herein provide a method for instantiating an EAS. In the method, in response to the deployed EAS not meeting the application information that the UE wants to access or the EAS is not instantiated in the current EDN, the EAS is instantiated to meet the request of the EEC. FIG. 2 shows a communication system to which a technical solution provided in at least one embodiment is applicable, and shows an edge application server and an edge enabler server on an edge data network side, and an application client and an edge enabler client on a terminal device side.

An EDN corresponds to one data network deployed at an edge, and is a local data network (local DN) or a local area data network (local area data network, LADN). The edge data network includes an edge enabler function, which uses a data network access identifier (data network access identifier, DNAI) and a data network name (data network name, DNN) identifier or a data network name and a data network service area (service area) identifier. Alternatively, the edge data network is considered as a data center deployed locally relative to a central cloud. The edge data network is identified by using the DNAI, and one edge data network includes a plurality of local data networks (local DN).

The EAS is a server application program deployed in the edge data network, and is also referred to as an application instance, an edge application instance, an MEC application (server), an EAS function, or the like. For example, applications such as social media software, augmented reality (augmented reality, AR), and virtual reality (virtual reality, VR) are deployed and run on the application instance (instance) of the EDN. One or more EASs is deployed for one application in one or more EDNs, and EASs deployed and running in different EDNs is considered as different EASs of one application. Different EASs of one application share one domain name. Different EASs of one application uses one anycast IP address or different IP addresses. The edge application server EAS further includes an application context of an application corresponding to the EAS. Optionally, the application context further includes a context of one or more application users who use the application in the EAS, for example, running status information related to the one or more application users who use the application, or a transaction identifier of subscription of the EAS to the one or more application users. Optionally, the application context also includes a subscription context, for example, a subscription transaction identifier, of one or more application users who use the application in the EAS and a core network.

The EES is deployed in the EDN, and provides an edge computing enabler service for an application instance deployed in the EDN, namely, the foregoing EAS, to better support deployment and running of an application in the MEC. The EES supports registration of the EAS, authentication and authorization on a terminal device (user equipment, UE), or authentication and authorization on an edge enabler client, and provide information about an application instance, such as IP address information, for the UE. Generally, one EAS is registered with one EES, or information about one EAS is configured on one EES through a management system. In this case, the EES is referred to as an EES associated with the EAS, and the EES controls (manage) registration or the EAS configured on the EES or the serving EES of the EAS. The EES further supports obtaining information about the application instance, including an identifier of the application instance and address information (such as the IP address information) of the application instance, and further sends the information about the application instance, such as an identifier of the application instance, to an edge data network configuration server (edge configuration server, ECS). The ECS is responsible for configuration of the EDN, for example, providing information about the EES for the UE, providing information about the EAS for the UE, interacting with a DNS of an application, to obtain information about the EAS, and the like. Further, the ECS further obtains the information about the application instance and the information about the IP address from another functional entity and stores the information. The MEC architecture model shown in FIG. 2 further shows the foregoing ECS.

An AC is a client program of an application on a terminal device side, and is a peer entity of the EAS on the terminal device side. The application client is used by an application user (user) to obtain an application service from an application server. The application client connects to an application server on the cloud to obtain the application service, or connects to an EAS that is deployed and runs in one or more EDNs to obtain the application service.

The EEC is a peer entity of the EES on the terminal device side. The EEC is configured to register information about the EEC and information about the application client AC with the EES, perform security authentication and authentication, obtain information about the EAS including address information (such as the IP address) of the EAS from the EES, and provide an edge computing enabler capability for the application client. For example, an EEC discovery service returns the IP address of the EAS to the application client.

As shown in FIG. 2, a communication connection is established between the application client AC on the terminal device side and the edge application server EAS; and a communication connection is established between the edge enabler client EEC on the terminal device side and the edge enabler server EES. After signing a service agreement with an application provider, an application user logs in to the application client AC deployed on the terminal device to use the application, and exchange transmission application data (application data) through the communication connection between the application client AC and the EAS. The application user further obtains a service provided by the edge enabler server EES from the edge enabler client EEC in a manner of an application programming interface (application programming interface, API) through the application client AC.

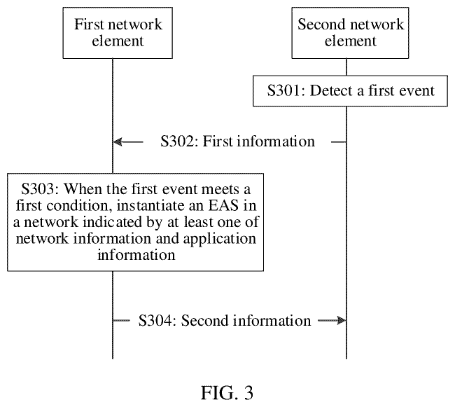

FIG. 3 is an example flowchart of a method for instantiating an EAS according to at least one embodiment. The method includes the following operations.

S301: A second network element detects a first event.

The second network element is an EES or an ECS. The ECS is one network element deployed in a centralized manner, and is not necessarily deployed in an EDN network. A deployment location of the ECS is not specifically limited in at least one embodiment. The first event includes at least one of the following.

1. An Available EAS Corresponding to a First Application is not Found in a First Network.

In S104, the EES determines whether the deployed EAS meets the first application that UE wants to access. In response to the EES determining that the EAS of the first application that the UE wants to access does not exist in the deployed EAS, the available EAS corresponding to the first application is not found in the first network. In S107, the EES searches for, based on application information, the EAS that meets the first application that the UE wants to access. In response to the EAS not being found, the available EAS corresponding to the first application is not found in the first network. For ease of description, at least one embodiment is described as that the available EAS is not found. Details are not described below again.

Optionally, in response to a delay and a bandwidth of the EAS not meeting the first application that the UE wants to access, the available EAS corresponding to the first application is not found in the first network. For example, in response to the first application that the UE wants to access having a high usage on the delay, an EAS that corresponds to the first application and that has been deployed in the first network has a low delay, and the delay is great during service processing, the EAS in the first network does not meet the first application that the UE wants to access.

2. An Available EES Corresponding to a First Application is not Found in a First Network.

In S102, the ECS searches for an EDN or an EES on which an EAS meeting the first application that the UE wants to access is deployed. In response to the ECS not finding the EDN or the EES, the available EES corresponding to the first application is not found, or the ECS is considered that the available EAS corresponding to the first application is not found. For ease of description, at least one embodiment is described as that the available EES is not found. Details are not described below again.

3. Performance Information of the EAS Corresponding to the First Application in the First Network.

The EES or the ECS determines EAS performance corresponding to the first application in the first network, for example, load (which includes one or more of a memory, a CPU, a bandwidth, a quantity of connections, a delay, and the like) of the EAS, whether the EAS is online, and the like. Optionally, in response to the EES or the ECS determining that the load of the EAS does not exceed a first value and the EAS is online, the performance information of the EAS is not reported. In response to the EES or ECS determining that the load of the EAS is greater than or equal to the first value, or the EAS breaks down, the performance information of the EAS is reported. The first value is determined based on an empirical value, for example, is 50% of the bandwidth of the EAS, 80% of the bandwidth, or the like. This is not specifically limited in at least one embodiment. For ease of description, the first value is described as EAS performance in at least one embodiment, and details are not described below again.

S302: The second network element sends first information to a first network element, and correspondingly, the first network element receives the first information from the second network element.

The first network element is an ASP or a management system. The first information includes network information and application information. The network information indicates the first network, and the application information indicates the first application. The network information includes at least one of a network identifier, a location identifier, an EES identifier, or an ECS identifier. The network identifier indicates one EDN network, for example, is a DNAI, a DNN, or the like. The location identifier indicates one node in the EDN network, the ECS identifier identifies one ECS, and the EES identifier identifies one EES. The application information includes an application identifier and an application performance usage. The application identifier indicates one application, for example, an EAS ID, an FQDN, or the like. The application performance usage indicates a performance usage of an application indicated by the application identifier, for example, a bandwidth usage, a delay usage, and the like. The first information further includes information about a first event that is related to the first application and that is in the first network.

The second network element sends the first information to the first network element based on the detected first event. In at least one embodiment, the EES or the ECS sends the first information to the ASP or the management system each time after detecting the first event. For example, in response to the ECS not finding an available EES in S102, the ECS sends the first information to the ASP or the management system. Alternatively, the EES or the ECS sends the first information to the ASP or the management system after detecting the first event for a plurality of times. In response to the EES or the ECS sending the first information after detecting the first event for a plurality of times, the first information further carries a quantity of times that the first event occurs. For example, the quantity of times that the ECS does not find an available EES, the quantity of times that the EES does not find an available EAS, the quantity of times that the EAS is overloaded, the EAS breaks down, or the like. Specifically, that the EES or the ECS sends the first information after detecting the first event for a plurality of times is: the quantity of times that the EES or the ECS detects the first event meets a preset quantity of times, for example, 10. For example, in response to detecting that the available EES is not found for 10 times, the EES or the ECS sends the first information to the ASP or the management system. Alternatively, the EES or the ECS detects the first event for a plurality of times in a specified periodicity, and sends the first information to the ASP or the management system after the specified periodicity expires.

In at least one embodiment, the first network element subscribes to the first event or the first information. For example, the management system or the ASP sends a subscription request to the EES or the ECS, and the subscription request is used to subscribe to the first information or the first event. In this way, the first network element subscribes to the first information or the first event, so that the first network element avoids missing the first information or the first event.

S303: The first network element determines, in response to the first event meeting a first condition, to instantiate, in a first network, an EAS corresponding to a first application.

The first condition includes at least one of the following:

Condition 1: A Quantity of Times that the Available EAS is not Found in the First Duration is Greater than or Equal to a First Threshold.

The first duration is determined in advance based on an empirical value, for example, 10 s or 20 s. The first threshold is determined in advance based on an empirical value, for example, five or six times. This is not specifically limited in at least one embodiment. Optionally, the ASP or the management system receives the first information for a plurality of times. In response to a quantity of times that the available EAS is not found in the first duration being greater than or equal to the first threshold, many UEs want to access the first application or one UE wants to access the first application for a plurality of times, but an EAS that provides a service for the first application is not instantiated in the first network. In this case, the management system or the ASP determines to instantiate, in the first network, the EAS that provides the service for the first application.

Optionally, in response to the EES sending the first information after detecting the first event for a plurality of times, the first information includes a quantity of times that the first event occurs. In this case, the condition 1 also includes that the quantity of times that the available EAS is not found is greater than or equal to a second value. The second value is the same as or different from the first threshold. This is not specifically limited in at least one embodiment.

Condition 2: A Quantity of Times that the Available EES is not Found in the Second Duration is Greater than or Equal to a Second Threshold.

The second duration is determined in advance based on an empirical value, for example, 8 s or 10 s. The second threshold is determined in advance based on an empirical value, for example, 10 times or 15 times. This is not specifically limited in at least one embodiment. The second duration is the same as or different from the first duration, and the first threshold is the same as or different from the second threshold. This is not specifically limited in at least one embodiment.

Optionally, the ASP or the management system receives the first information for a plurality of times. In response to a quantity of times that the available EES is not found in the second duration being greater than or equal to the second threshold, many UEs want to access the first application or a same UE wants to access the first application for a plurality of times. However, because the first network has not instantiated an EAS that provides a service for the first application, an EES on which the EAS that provides the service for the first application is deployed cannot be found. In this case, the management system or the ASP determines to instantiate, in the first network, the EAS that provides the service for the first application.

Optionally, in response to the ECS sending the first information after detecting the first event for a plurality of times, the first information includes a quantity of times that the first event occurs. In this case, the condition 2 also includes that the quantity of times that the available EES is not found is greater than or equal to a third value. The third value is the same as or different from the second threshold. This is not specifically limited in at least one embodiment.

Condition 3: Load of the EAS is Greater than or Equal to the Third Threshold.

In response to the EAS performance in the first information includes that the load of the EAS being greater than or equal to the third threshold, the EAS that provides the service for the first application in the first network cannot meet a usage of the UE. In this case, the ASP or the management system determines to instantiate, in the first network, the EAS that provides the service for the first application. The third threshold is 50%, 85%, or the like of the bandwidth of the EAS. This is not specifically limited in at least one embodiment.

Condition 4: EAS Breakdown.

In response to the EAS performance in the first information including EAS breakdown, to be specific, the EAS is offline and cannot provide a service, the ASP or the management system determines to instantiate, in the first network, the EAS that provides the service for the first application. Optionally, the EAS breakdown is: all EASs in the network break down, or a part of EASs in the network break down. For example, the EAS breakdown is: one EAS in the first network breaks down, or greater than or equal to half of EASs in the first network break down. This is not specifically limited in at least one embodiment.

In an example, the management system obtains, from the ASP in advance, application installation information that allows to be instantiated. In other words, the management system obtains authorization of the application that allows instantiation. The application installation information includes information such as an application identifier and an application description file. In response to the management system obtaining the authorization of the application that allows to be instantiated, the EES or the ECS sends the first information to the management system. In response to the first event meeting the first condition, the management system instantiates, in the first network, the EAS corresponding to the first application.

In another example, in response to the management system not obtaining a list of applications that allow to be instantiated and the application installation information, the EES or the ECS sends the first information to the ASP. In response to the first event meeting the first condition, the ASP sends an EAS instantiation request to the management system, to request the management system to instantiate, in the first network, the EAS that provides the service for the first application.

The instantiating the EAS corresponding to the first application includes: allocating, to the EAS, a virtual machine resource, a memory, a CPU, a bandwidth, and the like that are used by the application, or deploying, in the first network EDN, a server corresponding to the first application. An operation of instantiating the EAS is not specifically limited in at least one embodiment.

S304: The first network element sends second information to the second network element.

The second information indicates that the EAS of the first application is successfully instantiated.

In at least one embodiment, the management system sends the second information to the EES or the ECS. In response to the EES or the ECS sending the first information to the management system, after the EAS is instantiated, the management system sends the second information to the EES or the ECS.

Alternatively, the management system sends the second information to the ASP, and then the ASP sends the second information to the EES or the ECS. In response to the EES or the ECS sending the first information to the ASP, after the EAS is instantiated, the management system sends the second information to the ASP, and the ASP sends the second information to the EES or the ECS.

Optionally, the EES receives the second information from the ASP or the management system, and sends the information about the instantiated EAS corresponding to the first application to the EEC. Alternatively, because the EAS corresponding to the first application has been deployed on the EES, the ECS sends EES information to the EEC, and after receiving the EES information, the EEC sends an EAS discovery request to the EES, for example, S107.

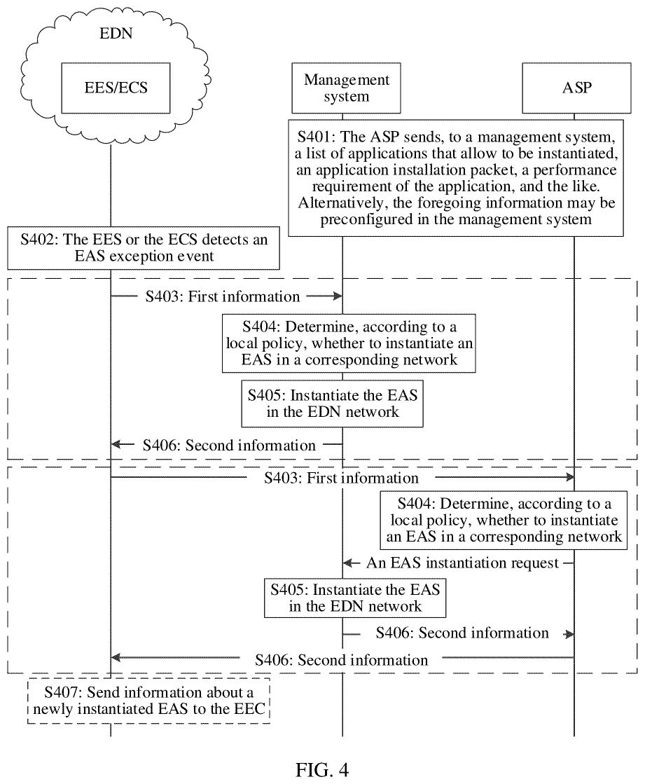

The following describes in detail, based on FIG. 4, a method for instantiating an EAS according to at least one embodiment.

FIG. 4 is an example flowchart of still another method for instantiating an EAS according to at least one embodiment. The method includes the following operations.

Optionally, S401: An ASP sends, to a management system, a list of applications that allow to be instantiated, application installation information, a performance of the application, and the like. Alternatively, the foregoing information is preconfigured in the management system. The management system stores the application installation information that allows to be instantiated, the performance of the application, and the like.

S402: An EES or an ECS detects an EAS exception event.

The EES detects the EAS exception event, which includes: The EES receives an EAS discovery request from the EEC, but the EES does not find an EAS that meets a condition, or the EES receives a registration request from the EEC, but the EES does not find an EAS that meets a condition. The condition meeting is meeting a usage of an application that UE wants to access. Alternatively, the EES monitors a performance change of the EAS. For example, whether the EAS is overloaded or breaks down.

The ECS detects the EAS exception event, which includes: The ECS receives an EES discovery request from the EES, but the ECS does not find the EES that meets the condition, or the ECS receives a service configuration request from the EEC, but the ECS does not find the EES that meets the condition. The EES that meets the condition is: an EAS that meets a usage of an application that the UE wants to access is deployed in the EES.

S403: The EES or the ECS sends first information to a management system or an ASP, and sends the detected EAS exception event to the management system or the ASP. Alternatively, performance of the EAS is carried in the first information and sent to the management system or the ASP.

In response to S401 being performed, the EES or the ECS directly sends the first information to the management system.

In an example, in response to the EES or the ECS detecting the EAS exception event and reporting the EAS exception event, the first information does not include a quantity of times that the EAS exception event occurs, or a quantity of times that the EAS exception event occurs is 1 by default.

In another example, in response to the EES or the ECS reporting the EAS exception event only in response to detecting a plurality of EAS exception events, the first information includes a quantity of times that the EAS exception event occurs.

S404: The ASP or the management system determines, according to a local policy, whether to instantiate the EAS in a corresponding network.

For example, the ASP or the management system determines whether the EAS exception event or the EAS performance meets the first condition. For details, refer to related descriptions in the first condition, and details are not described herein again.

Optionally, in response to the EES or the ECS sending the first information to the ASP, the ASP sends the EAS instantiation request to the management system in response to determining that the EAS exception event or the EAS performance meets the first condition. The EAS instantiation request includes application information and network information, and is used to determine a network on which an EAS of an application is deployed.

S405: The management system instantiates the EAS in an EDN network.

The management system instantiates, in an EDN network indicated by the network information based on the application information and the network information, the EAS of the application indicated by the application information. The management system allocates, to the EAS, a virtual machine resource, a memory, a CPU, a bandwidth, and the like that are used by the application. An operation of instantiating the EAS is not specifically limited in at least one embodiment.

For example, the management system first sends a message to a management network element of an edge network, for example, an MEC platform management (MEC Platform management, MEPM), and then the management network element of the edge network interacts with the EES or the MEP to instantiate the EAS.

S406: The management system sends second information to the EES or the ECS, to notify the EES or the ECS that the EAS is successfully instantiated.

Optionally, the management system first notifies the ASP that the EAS instantiation succeeds, and then the ASP notifies the EES or the ECS that the EAS instantiation succeeds. A procedure of notifying the EES or the ECS that the EAS is successfully instantiated shown in FIG. 4 is merely an example.

Optionally, S407 is further performed.

S407: The EES sends information about the newly instantiated EAS to the EEC; or because a new EAS is deployed on the EES, the ECS sends EES information to the EEC, and after receiving the EES information, the EEC sends an EAS discovery request to the EES.

Based on the foregoing solution, an EES or ECS detection mechanism is defined, to report an event to the management system. The management system determines, based on the reported event, whether to dynamically instantiate the EAS, and the management system deploys the EAS as used. This significantly improves efficiency of operation and maintenance management.

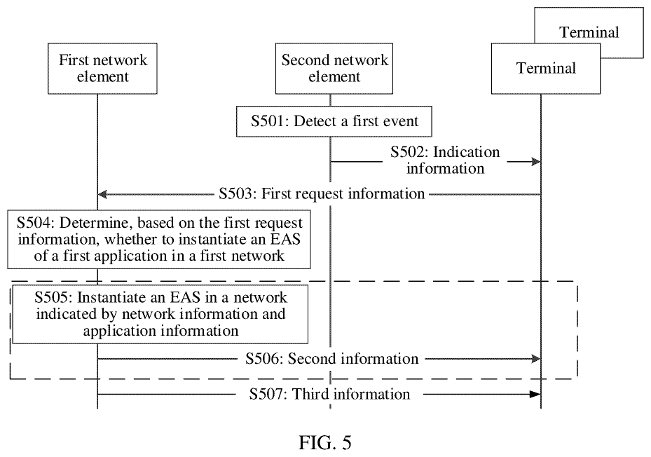

Refer to FIG. 5. At least one embodiment provides another method for instantiating an EAS. FIG. 5 is an example flowchart of still another method for instantiating an EAS according to at least one embodiment. The method includes the following operations.

S501: A second network element detects a first event.

The second network element is an EES or an ECS. For the first event, refer to related descriptions in the method embodiment shown in FIG. 3. Details are not described herein again.

S502: The second network element sends indication information to one or more terminals.

The one or more terminals is an EEC functional module in the terminal.

The EES sends the indication information to the EEC in response to an available EAS not being found, or an EAS is overloaded or breaks down. The ECS sends the indication information to the EEC in response to an available EES not being found, or an EAS is overloaded or breaks down.

The indication information indicates that EAS search fails or EES search fails, or indicates that EEC registration fails, or the indication information explicitly indicates that a first application that UE wants to access is to dynamically instantiate the EAS, or the indication information indicates that performance of the EAS deployed in a current EDN cannot meet a performance requested by the UE.

S503: The one or more terminals send first request information to the first network element.

Optionally, the EEC sends the indication information to an AC. The first network element is an ASP, a management system, or a user app LCM proxy (user app LCM proxy, UEAPPLCM proxy). The foregoing UEAPPLCM proxy is used by a user to request an entity of services such as application-related instantiation and termination.

The first request information includes network information, application information, and a terminal identifier. The terminal identifier is a subscription permanent identifier (subscription permanent identifier, SUPI), a generic public subscription identifier (generic public subscription identifier, GPSI), or the like, and is used to determine which UE wants to access a first application.

S504: The first network element determines, based on the first request information, whether to instantiate an EAS of a first application in a first network.

The first network element determines, based on a local policy or configuration, whether to instantiate the EAS of the first application in the first network. For example, in response to a quantity of UEs that want to access the first application reaching a first threshold, the EAS that instantiates the first application in the first network is determined. The quantity of UEs is determined through a quantity of terminal identifiers received by the first network element. In response to the quantity of terminal identifiers reaching the first threshold, the quantity of UEs that want to access the first application reaches the first threshold. For another example, in response to the first network element determining, based on the quantity of first requests, that a second threshold is reached, a usage for accessing the first application is large, and therefore, the first network element determines the EAS that instantiates the first application in the first network. The first threshold and the second threshold is determined in advance based on an empirical value, for example, 1 or 5. This is not specifically limited in at least one embodiment.

Alternatively, in response to a subscription level of the terminal identified by the terminal identifier being higher than or equal to a specified level, the EAS that instantiates the first application in the first network is determined. The first request information includes the subscription level of the terminal identified by the terminal identifier. Alternatively, the first network element stores a correspondence between the terminal identifier and the subscription level, and the first network element determines, in the stored correspondence, whether a subscription level corresponding to the terminal identifier included in the first request information is higher than or equal to the specified level.

In an example, the management system obtains, from the ASP in advance, application installation information that allows to be instantiated. In other words, the management system obtains authorization of the application that allows instantiation. The application installation information includes information such as an application identifier and an application description file. In response to the management system obtaining the authorization of the application that allows instantiation, the terminal sends the first request information to the management system. The management system determines, based on the first request information, whether to instantiate the EAS of the first application in the first network. In response to the management system determining to instantiate the EAS of the first application in the first network, S505 is performed; otherwise, the management system performs S507.

In another example, in response to the management system not obtaining the application installation information that allows to be instantiated, the terminal sends the first request information to the ASP or the UEAPPLECM proxy. The ASP or the UEAPPLECM proxy determines, based on the first request information, whether to instantiate the EAS of the first application in the first network. In response to the ASP or the UEAPPLCM proxy determining to instantiate the EAS of the first application in the first network, the ASP or the UEAPPLCM proxy sends the second request information to the management system. The second request information includes the application information and the network information. The management system instantiates, in the first network, the EAS that provides a service for the first application, to be specific, performs S505. In response to the ASP or the UEAPPLCM proxy determining not to instantiate the EAS of the first application in the first network, the ASP or the UEAPPLCM proxy performs S507.

S505: The first network element instantiates an EAS that provides a service for the first application in the first network.

For an operation that the first network element instantiates the EAS, refer to the foregoing related descriptions. Details are not described herein again.

S506: The first network element sends second information to the one or more terminals.

The second information indicates that the EAS is successfully instantiated. Optionally, the management system, the ASP, or the UEAPPLCMA proxy first notifies the EEC that the EAS is successfully instantiated, and then the EEC notifies the AC that the EAS is successfully instantiated.

In an example, in response to the one or more terminals sending the first request information to the management system, the management system sends the second information to the one or more terminals after instantiating the EAS.

In another example, in response to the one or more terminals sending the first request information to the ASP or the UEAPPLCM proxy, after instantiating the EAS, the management system sends the second information to the ASP or the UEAPPLCM proxy, and the ASP or the UEAPPLCM proxy sends the second information to the one or more terminals.

S507: The first network element sends third information to the one or more terminals.

The third information indicates that the EAS of the first application is not found in the first network.

In response to the one or more terminals sending the first request information to the management system, the management system sends the third information to the one or more terminals. In response to the one or more terminals sending the first request information to the ASP or the UEAPPLCM proxy, the ASP or the UEAPPLCM proxy sends the third information to the one or more terminals.

Based on the foregoing solution, the management system instantiates the EAS based on a usage of the UE, so that differentiated service experience is provided for a user, and efficiency of operation and maintenance management is improved.

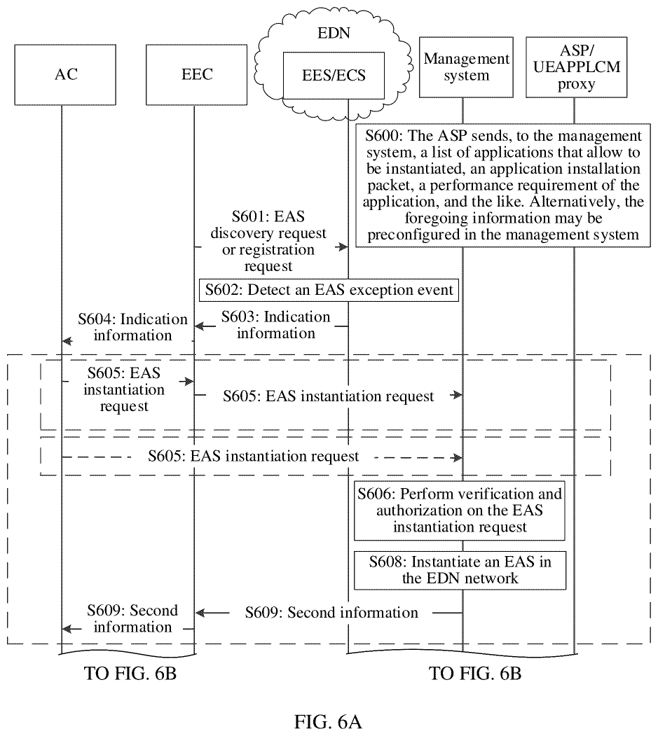

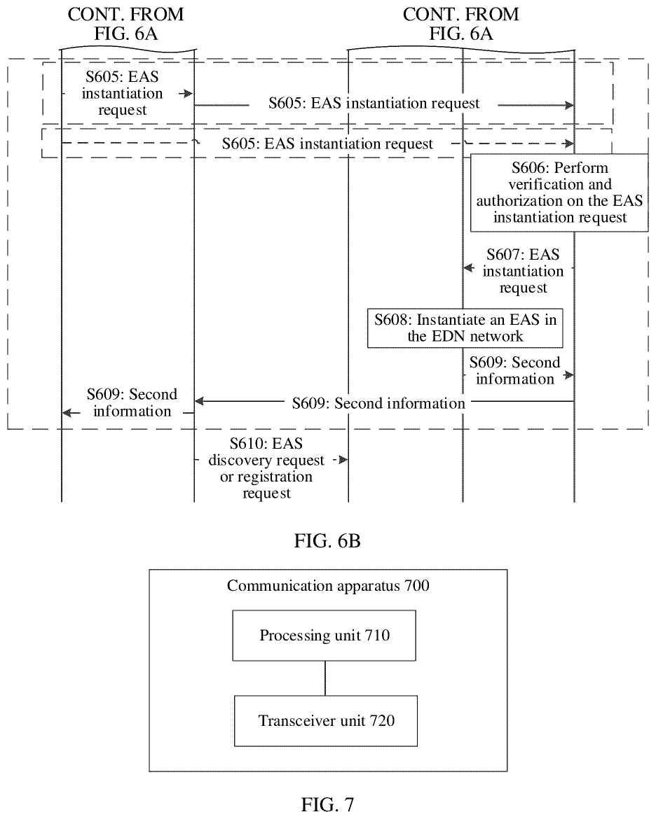

The following describes in detail, through FIG. 6A and FIG. 6B, a method for instantiating an EAS according to at least one embodiment.

FIG. 6A and FIG. 6B are an example flowchart of still another method for instantiating an EAS according to at least one embodiment. The method includes the following operations.

Optionally, S600 is the same as S401.

S601: An EEC sends an EAS discovery request or a registration request to an EES.

The EAS discovery request or the registration request includes application information.

Alternatively, the EEC sends a service configuration request to an ECS, where the service configuration request includes the application information.

S602 is the same as S402.

S603: The EES or an ECS sends indication information to the EEC.

The indication information indicates that the EAS is to be instantiated. For details, refer to related descriptions in the method embodiment shown in FIG. 5. Details are not described herein again.

Optionally, the EEC performs the following operation S604.

S604: The EEC sends the indication information to an AC.

S605: The EEC sends an EAS instantiation request to a UEAPPLCM proxy/ASP/management system.

The EAS instantiation request includes a network identifier or a location identifier, application information, a UE identifier, and the like. For details, refer to related descriptions in the method embodiment shown in FIG. 3 to FIG. 5. Details are not described herein again.

In an example, the AC first sends the EAS instantiation request to the EEC, and then the EEC sends the EAS instantiation request to the ASP or the UEAPPLCM proxy. The ASP or UEAPPLCM proxy sends the EAS instantiation request to the management system. The EAS instantiation request includes network information and application information, and does not include a terminal identifier.

In another example, the AC sends the EAS instantiation request to the ASP or the user app LCM proxy.

In yet another example, in response to the foregoing operation S600 having been performed, the AC/EEC sends the EAS instantiation request to the management system.

S606: The UEAPPLCM proxy/ASP/management system performs verification and authorization on the EAS instantiation request.

For example, whether the request is proper is determined based on a local policy or configuration. For details, refer to related descriptions in the method embodiment shown in FIG. 5. Details are not described herein again.

Optionally, in response to the AC/EEC sending the EAS instantiation request to the ASP or the UEAPPLCM proxy, the ASP or the UEAPPLCM proxy performs verification and authorization on the EAS instantiation request. After the verification succeeds, the following operation S607 is performed.

S607: The UEAPPLCM proxy/ASP sends, to the management system, the EAS instantiation request that carries network information and application information.

In response to the AC/EEC sending the EAS instantiation request to the management system, the management system performs verification on the EAS instantiation request. The management system includes network elements such as an operation support system (operation support system, OSS), an MEC orchestrator (MEC orchestrator, MEO), and an MEPM.

S608 is the same as S405.

S609: The UEAPPLCM proxy/ASP/management system sends second information to the AC/EEC, to notify the AC/EEC that the EAS is successfully instantiated.

In an example, the management system notifies the UEAPPLCM proxy/ASP that the EAS is successfully instantiated, and then the UEAPPLCM proxy/ASP notifies the EEC/AC that the EAS is successfully instantiated.

In another example, the EEC is first notified that the EAS is successfully instantiated, and the EEC notifies the AC that the EAS is successfully instantiated, or the AC is first notified that the EAS is successfully instantiated, and the AC notifies the EEC that the EAS is successfully instantiated.

A procedure of notifying the AC/EEC that the EAS is successfully instantiated shown in FIG. 6A and FIG. 6B is merely an example.

Optionally, the following operation S610 is performed.

S610: The EEC resends the request in S601.

Based on the foregoing solution, UE sends a dynamic EAS instantiation request to the UEAPPLCM proxy, the ASP, or the management system, to provide differentiated service experience for a user. The management system deploys the EAS as used. This improves efficiency of operation and maintenance management.

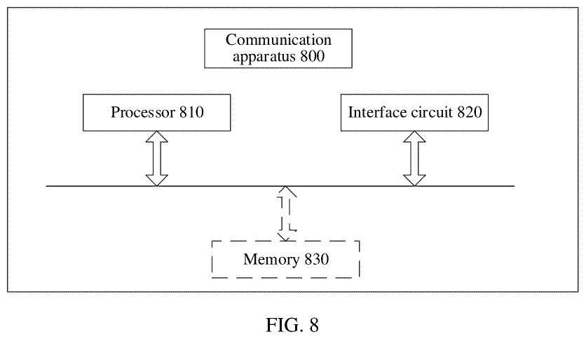

FIG. 7 and FIG. 8 are schematic diagrams of structures of communication apparatuses according to at least one embodiment. These communication apparatuses are configured to implement functions of the first network element, the second network element, or the terminal in the foregoing method embodiments, and therefore also implements beneficial effects of the foregoing method embodiments.

As shown in FIG. 7, a communication apparatus 700 includes a processing unit 710 and a transceiver unit 720. The communication apparatus 700 is configured to implement functions of the first network element, the second network element, or the terminal in the method embodiment shown in FIG. 3 or FIG. 5.

In response to the communication apparatus 700 being configured to implement a function of the first network element in the method embodiment shown in FIG. 3, the transceiver unit is configured to receive first information from a second network element, where the first information includes network information and application information, the network information indicates a first network, the application information indicates a first application, and the first information further includes information about a first event that is related to the first application and that is in the first network; and the first event includes at least one of the following: an edge application server corresponding to the first application is not found in the first network, the edge enabler server corresponding to the first application is not found in the first network, and performance information of the edge application server corresponding to the first application in the first network. The processing unit is configured to determine, in response to the first event meeting a first condition, to instantiate a first edge application server corresponding to the first application in the first network.

In response to the communication apparatus 700 being configured to implement a function of the first network element in the method embodiment shown in FIG. 5, the transceiver unit is configured to receive first request information from one or more terminals, where the first request information is used to request to instantiate an edge application server; the first request information includes network information, application information, and a terminal identifier; and the network information indicates a first network, the application information indicates a first application, and the terminal identifier identifies a terminal that sends the first request information; and the processing unit is configured to determine, based on the first request information, whether to instantiate the edge application server corresponding to the first application in the first network.

In response to the communication apparatus 700 being configured to implement a function of the second network element in the method embodiment shown in FIG. 3, the processing unit is configured to detect a first event, where the first event includes at least one of the following: an edge application server corresponding to the first application is not found in the first network, the edge enabler server corresponding to the first application is not found in the first network, and performance information of the edge application server corresponding to the first application in the first network; the transceiver unit is configured to send first information to a first network element or sending indication information to one or more terminals based on the detected first event; the first information includes network information and application information, and the indication information indicates that an edge application server is to be instantiated; and the network information indicates the first network, and the application information indicates the first application.

In response to the communication apparatus 700 being configured to implement a function of the terminal in the method embodiment shown in FIG. 5, the transceiver unit is configured to receive indication information from an edge enabler server or an edge network configuration server, where the indication information indicates that the edge application server fails to be found, or an edge enabler client fails to be registered, or the edge application server is to be instantiated. The processing unit is configured to generate request information based on the indication information. The request information includes network information, application information, and a terminal identifier; and the network information indicates a first network, the application information indicates a first application, and the terminal identifier identifies a terminal that sends the request information. The transceiver unit is further configured to send the request information to a first network element.

For more detailed descriptions of the processing unit 710 and the transceiver unit 720, directly refer to related descriptions in the method embodiment shown in FIG. 3 or FIG. 4. Details are not described herein again.

As shown in FIG. 8, a communication apparatus 800 includes a processor 810 and an interface circuit 820. The processor 810 and the interface circuit 820 are coupled to each other. The interface circuit 820 is a transceiver or an input/output interface. Optionally, the communication apparatus 800 further includes a memory 830, configured to: store instructions to be executed by the processor 810, store input data used for running the instructions by the processor 810, or store data generated after the processor 810 runs the instructions.

In response to the communication apparatus 800 being configured to implement the method shown in FIG. 3 or FIG. 5, the processor 810 is configured to implement a function of the processing unit 710, and the interface circuit 820 is configured to implement a function of the transceiver unit 720.

In response to the communication apparatus being a chip used in a terminal, the chip in the terminal implements functions of the terminal in the foregoing method embodiments. The terminal chip receives information from another module (for example, a radio frequency module or an antenna) in the terminal, where the information is sent by the first network element to the terminal; or the terminal chip sends information to another module (for example, a radio frequency module or an antenna) in the terminal, where the information is sent by the terminal to the first network element.

In response to the communication apparatus being a module applied to the first network element, the first network element module implements a function of the first network element in the foregoing method embodiments. The first network element module receives information from another module (such as a radio frequency module or an antenna) in the first network element, where the information is sent by the terminal or the second network element to the first network element; or the first network element module sends information to another module (such as a radio frequency module or an antenna) in the first network element, where the information is sent by the first network element to the terminal or the second network element.

In response to the communication apparatus being a module applied to the second network element, the second network element module implements a function of the second network element in the foregoing method embodiments. The second network element module receives information from another module (such as a radio frequency module or an antenna) in the second network element, where the information is sent by the first network element to the second network element; or the first network element module sends information to another module (such as a radio frequency module or an antenna) in the first network element, where the information is sent by the second network element to the first network element.

The processor in at least one embodiment is a central processing unit (Central Processing Unit, CPU), or is another general-purpose processor, a digital signal processor (Digital Signal Processor, DSP), an application-specific integrated circuit (Application-Specific Integrated Circuit, ASIC), a field programmable gate array (Field Programmable Gate Array, FPGA) or another programmable logic device, a transistor logic device, a hardware component, or any combination thereof. The general-purpose processor is a microprocessor or any regular processor or the like.

The method steps in at least one embodiment are implemented in a hardware manner, or is implemented in a manner of executing software instructions by the processor. The software instructions include a corresponding software module. The software module is stored in a random access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well-known in the art. For example, a storage medium is coupled to a processor, so that the processor reads information from the storage medium and writes information into the storage medium. Certainly, the storage medium is a component of the processor. The processor and the storage medium are disposed in an ASIC. In addition, the ASIC is located in a first network element, a second network element, or a terminal. Certainly, the processor and the storage medium exist in the first network element, the second network element, or the terminal as discrete components.

All or some of the foregoing embodiments are implemented by using software, hardware, firmware, or any combination thereof. In response to software being used to implement the embodiments, all or a part of the embodiments are implemented in a form of a computer program product. The computer program product includes one or more computer programs and instructions. In response to the computer programs or instructions being loaded and executed on a computer, all or some of the procedures or functions in at least one embodiment are executed. The computer is a general-purpose computer, a dedicated computer, a computer network, a network device, user equipment, or another programmable apparatus. The computer programs or instructions are stored in a computer-readable storage medium, or are transmitted from a computer-readable storage medium to another computer-readable storage medium. For example, the computer programs or instructions are transmitted from a website, computer, server, or data center to another website, computer, server, or data center in a wired manner or in a wireless manner. The computer-readable storage medium is any usable medium that is able to be accessed by a computer, or a data storage device, such as a server or a data center, integrating one or more usable media. The usable medium is a magnetic medium, for example, a floppy disk, a hard disk, or a magnetic tape; or is an optical medium, for example, a digital video disc; or is a semiconductor medium, for example, a solid state disk. The computer-readable storage medium is a volatile or nonvolatile storage medium, or includes two types of storage media: a volatile storage medium and a nonvolatile storage medium.

In at least one embodiment, unless otherwise stated or there is a logic conflict, terms and/or descriptions between different embodiments are consistent and is mutually referenced, and technical features in different embodiments is combined based on an internal logical relationship thereof, to form a new embodiment.

In at least one embodiment, at least one means one or more, and a plurality of means two or more. “And/Or” is an association relationship for describing associated objects, and indicates that three relationships exist. For example, A and/or B indicates the following cases: Only A exists, both A and B exist, and only B exists, where A and B are in a singular form or a plural form. In the text descriptions of at least one embodiment, the character “/” generally indicates an “or” relationship between the associated objects. In a formula in at least one embodiment, the character “/” indicates a “division” relationship between the associated objects. “Including at least one of A, B, and C” represents: including A; including B; including C; including A and B; including A and C; including B and C; and including A, B, and C.

Various numbers in at least one embodiment are merely used for differentiation for ease of description, and are not used to limit the scope of embodiments described herein. The sequence numbers of the foregoing processes do not mean execution sequences, and the execution sequences of the processes should be determined based on functions and internal logic of the processes.

1. A communication method, comprising:
receiving first information, wherein the first information includes network information and application information, the network information indicates a first network, the application information indicates a first application, and the first information further includes a quantity of times that a first event occurs; and the first event is that an edge application server corresponding to the first application is not found in the first network; and
in response to the first event meeting a first condition, utilizing a procedure to instantiate a first edge application server corresponding to the first application in the first network.

2. The method according to claim 1, wherein the meeting the first condition includes meeting the first condition that is that the quantity of times that the first event occurs is greater than or equal to a second value.

3. The method according to claim 1, wherein the method is performed by an application service provider, and the utilizing the procedure to instantiate the first edge application server corresponding to the first application in the first network includes:
sending an edge application server instantiation request to a management system, wherein the edge application server instantiation request is used to instantiate the first edge application server, and the edge application server instantiation request includes the network information and the application information.

4. The method according to claim 1, wherein the first information is from a second network element, and the method further comprises:
sending a subscription request to the second network element, wherein the subscription request is used to subscribe to the first information.

5. The method according to claim 1, wherein the network information is a location identifier.

6. The method according to claim 1, wherein the network information includes at least one of a network identifier, an edge enabler server identifier, or an edge configuration server identifier.

7. A communication method, comprising:
detecting a first event, wherein the first event is that an edge application server corresponding to a first application is not found in a first network; and
sending, based on the detected first event, first information, wherein the first information includes network information and application information, the network information indicates the first network, the application information indicates the first application, and the first information further includes a quantity of times that the first event occurs.

8. The method according to claim 7, wherein the first information is for determining to instantiate a first edge application server corresponding to the first application in the first network.

9. The method according to claim 7, wherein the first information is sent to a first network element, and the method further comprises:
receiving a subscription request from the first network element, wherein the subscription request is used to subscribe to the first information.

10. The method according to claim 7, wherein the network information is a location identifier.

11. A communication apparatus, comprising:
at least one memory storing programming instructions; and
at least one processor coupled to the memory, wherein the least one processor is configured to execute the programming instructions to cause the at least one processor to perform operations comprising:
receiving first information from a second network element, wherein the first information includes network information and application information, the network information indicates a first network, the application information indicates a first application, and the first information further includes a quantity of times that a first event occurs; and the first event is that an edge application server corresponding to the first application is not found in the first network; and
in response to the first event meeting a first condition, utilizing a procedure to instantiate a first edge application server corresponding to the first application in the first network.

12. The apparatus according to claim 11, wherein the first condition that the quantity of times that the first event occurs is greater than or equal to a second value.

13. The apparatus according to claim 11, wherein the apparatus is an application service provider, wherein the processor is further configured to utilize the procedure to instantiate the first edge application server corresponding to the first application in the first network by:
sending an edge application server instantiation request to a management system, wherein the edge application server instantiation request is used to instantiate the first edge application server, and the edge application server instantiation request includes the network information and the application information.

14. The apparatus according to claim 11, wherein the processor is further configured to perform operations for:
sending a subscription request to the second network element, wherein the subscription request is used to subscribe to the first information.

15. The apparatus according to claim 11, wherein the network information is a location identifier.

16. The apparatus according to claim 11, wherein the network information includes at least one of a network identifier, an edge enabler server identifier, or an edge configuration server identifier.

17. A communication apparatus, comprising:
at least one memory storing programming instructions;
at least one processor coupled to the memory, wherein the least one processor is configured to execute the programming instructions to cause the at least one processor to perform operations comprising:
detecting a first event, wherein the first event is that an edge application server corresponding to a first application is not found in a first network; and
sending, based on the detected first event, first information to a first network element, wherein the first information includes network information and application information, the network information indicates the first network, the application information indicates the first application, and the first information further includes a quantity of times that the first event occurs.

18. The apparatus according to claim 17, wherein the first information is for determining to instantiate a first edge application server corresponding to the first application in the first network.

19. The apparatus according to claim 17, wherein the at least one processor is further configured to perform operations for:
receiving a subscription request from the first network element, wherein the subscription request is used to subscribe to the first information.

20. The apparatus according to claim 17, wherein the network information is a location identifier.
